(19) United States
(12) Patent Application Publication
(10) Pub. No.: US 2023/0264893 A1
(43) Pub. Date: Aug. 24, 2023

(54) SELF-CONTAINED AUTOMATIC TWO STAGE HYDRAULIC CART LIFTING SYSTEM

(71) Applicant: Ryan Collins, Tahoe City, CA (US)

(72) Inventors: Ryan Mitchell Collins, Tahoe City, CA (US); David William Ellsworth, Loyalton, CA (US)

(73) Assignee: Tahoe Truckee Disposal Co., Inc., Tahoe City, CA (US)

(21) Appl. No.: 17/675,072

(22) Filed: Feb. 18, 2022

(51) Int. Cl. B65F 1/14; B65F 1/10

(52) U.S. Cl. CPC B65F 1/1452; B65F 1/10

(57) ABSTRACT

A self-contained electro-hydraulic system for trash collection is provided. The system comprises boxlike steel trash collection bin and a hydraulically activated trash cart lifter mounted on an outward-facing front surface of the bin. The system also comprises a control unit mounted on a side surface of the bin comprising a 12-volt battery, an electric motor, a rotator, and a two-stage hydraulic pump. The system hydraulically causes the lifter to grasp a trash cart positioned proximate the gripper. The system also changes, based on hydraulic pressure measurements, a stage of the pump from a first stage of about 5 gallons per minute to a second stage of about 1-2 gallons per minute. The system also lifts and tilts the cart based on the change in stage, enabling contents of the cart to fall. Power for the pump and lifting of the cart is supplied entirely by the 12-volt battery.

### FIELD OF THE DISCLOSURE

The present disclosure is in the field of sanitation. More particularly, the present disclosure provides a fully self-contained automatic two stage hydraulic system in a 12-volt environment attached entirely to a collection bin that hydraulically powers a lifter to grasp, lift, and empty trash carts into the bin.

### BACKGROUND

Many sanitation companies, municipal sanitation departments, and other trash collectors are confronted with problems associated with trash pickup locations that are difficult to reach and service because of heavily trafficked, narrow, or windy roads or road surfaces that are in poor condition. Some sanitation customers are located great distances from one another in rural areas. A typical front-loading or side-loading compactor truck may be too large to safely navigate such roads. Operating a large compactor truck in a rural or rugged area where collection locations may be far apart may consume excessive fuel and unduly stress a large vehicle. In addition, covering many miles before a truck is sufficiently full may not be economically feasible. Operating a small truck, which may make more sense in areas of rough road conditions or remote customers, may also not make economic sense as such trucks have limited space for trash and may require more manpower to lift and empty trash containers resulting in higher labor and associated expense. Smaller trucks that do have compactor apparatus must be outfitted with onboard hydraulic systems, which requires significant vehicle retrofit, and can cross-contaminate hydraulic systems across a fleet of such smaller trucks.

### BRIEF DESCRIPTION OF THE FIGURES

FIG. 1 is an image of a self-contained electro-hydraulic system according to an embodiment of the present disclosure.

FIG. 2 is an image of a self-contained electro-hydraulic system according to an embodiment of the present disclosure.

FIG. 3 is an image of a trash cart according to an embodiment of the present disclosure.

FIG. 4 is a schematic diagram of a self-contained electro-hydraulic system according to an embodiment of the present disclosure.

FIG. 5 is an image of a self-contained electro-hydraulic system according to an embodiment of the present disclosure.

FIG. 6 is an image of a self-contained electro-hydraulic system according to an embodiment of the present disclosure.

FIG. 7 is an image of a self-contained electro-hydraulic system according to an embodiment of the present disclosure.

FIG. 8 is an image of a self-contained electro-hydraulic system according to an embodiment of the present disclosure.

FIG. 9 is an image of a self-contained electro-hydraulic system according to an embodiment of the present disclosure.

FIG. 10 is an image of a self-contained electro-hydraulic system according to an embodiment of the present disclosure.

FIG. 11 is an image of a self-contained electro-hydraulic system according to an embodiment of the present disclosure.

### DETAILED DESCRIPTION

Systems and methods described herein provide a fully self-contained automatic two stage hydraulic system in a 12-volt environment for powering a cart lifter to grasp, raise, and empty full trash carts. The system is attached to a collection bin of between three and eight cubic yards in volume and does not rely on hydraulic apparatus of a medium-duty truck that may periodically move the bin. The system also may not rely on outside electrical power over the course of several hours of lifting and emptying of carts.

The system includes a 12-volt battery that completely powers the hydraulics of the system, which reside entirely on the bin, in most embodiments on a side panel of the bin. The battery may receive recharging which is accessible from the medium-duty truck to which the bin remains attached for safety and ease of transportation purposes in most embodiments.

The lifter, which may also be referred to a a gripper or tipper, is attached to a front surface of the bin. Hydraulic lines run from the system on the side of the bin to the lifter on the front of the bin. Controls for the system may be located in a panel on a side of the bin either near the hydraulic and electrical components of the system or distant therefrom, for example on a different panel of the bin.

When a trash cart is positioned in front of and within reach of the lifter, the system, upon instruction, hydraulically causes the lifter to grasp and commence lifting the cart. When hydraulic relief pressure reaches a given pressure threshold which may be due to the weight of the cart, the system automatically distributes hydraulic load by switching to a lower stage via use of a pressure relief valve, a mechanical component. When the system mechanically senses that the load is heavier than the first stage can support (via the internal pressure-sensing valve or pressure relief valve”) the system transitions to the second stage. This two-stage system allows for sufficient motor RPM and lifting from 600-2000 psi. The first stage is calibrated for a flow rate of 5 Gallons per minute (GPM) up to 600 psi. As greater physical load is applied to the lifter, the second stage transitions to 1-2 GPM up to 2,000 psi. The detection of the need for greater hydraulic pressure and change in stage are handled entirely by the system. The 12-volt battery provides all of the power that is needed for an extended period to lift many carts of differing weights and fill the bin.

The bin may be moved between different points at a single collection site (for example houses or buildings within a neighborhood, office park, or industrial park) or between multiple collection sites (for example between nearby neighborhoods) by a medium-duty truck that lifts the bin via forks at the rear area of the truck. The bin has pockets on each side into which the forks may be inserted, thus enabling the bin to be lifted and moved. The bin is not in most embodiments lifted such that it is raised high enough to fully rest upon a bed of the medium-duty truck, if such bed area even exists on a given medium-duty truck. Instead, the bin is lifted several feet off the ground and held by the medium-duty truck with the bin tilted forward at an angle. The medium-duty truck may then safely carry the bin between points at a single collection site or between collection sites, even at relatively high speeds. As the bin typically does not have a lid and instead has an open top, a tarp may be used to cover the open top of the bin while being transported by the medium-duty truck.

When the bin is full and/or a collection route or work shift ends such that the bin needs to be emptied and made ready for the next day, the medium-duty truck may carry the bin to a central location. There, the medium-duty truck may release the bin by setting it down on flat pavement and decoupling from the bin by removing its forks from pockets of the bin and driving a short distance away. A large front-loading compactor truck may approach the bin, insert its forks into the bin's pockets. The large compactor truck then lifts the bin and empties the bin into the compactor truck's own large container where the contents are compacted. The compactor truck is large enough to handle the contents of many bins.

Once the compactor truck has emptied the bin, the medium-duty truck may then return to the bin, insert its forks into the side pockets of the bin, lift the bin, and then return to pick up locations and continue lifting and emptying carts or alternatively return to a yard, depot, or other secure home location of the trash collector where the bin may be stored overnight or until needed again.

The components of the system are modular. The bin may be a standard trash bin of about between three to eight cubic yards in volume. The lifter may be a Perkins Gripper Model #D6098B-56C-27K, but it may also be any one of many similar devices provided by various manufacturers. In embodiments, the lifter may be interchangeably referred to as a tipper or gripper.

Medium-duty trucks and some heavy-duty trucks may refer to truck classes 5-7, which have a gross vehicle weight rating range of 19,501-33,000 lbs. The medium-duty truck described herein may be a Ford model F550, a Chevrolet Silverado 5500HD/International CV, a Dodge Ram 5500, an Isuzu NRR, a Freightliner Business Class M2 106, a Kenworth T170, a Peterbilt 325, or another model.

The lifting mechanism including forks of the medium-duty truck may be provided by various vendors in the truck-mounted lifting systems industry. The bin does not use any hydraulic power or equipment of the truck. The truck requires no hydraulic retrofit to accommodate the system provided herein.

In a typical use case, the bin would remain attached to the medium-duty truck over the course of a workday as the medium-duty truck makes it rounds to collection points. While 12-volt battery in the bin may have enough power to handle multiple grasping and lifting of carts on its own over a portion of a day, in most cases the bin maintains an electrical and physical attachment to the medium-duty truck. Such electrical attachment may be via cable extending from the truck to the bin and is not high voltage. A commercial class battery is not needed in the truck for the purpose of recharging the on-board 12-volt battery in the bin. No electrical upgrade to the medium-duty truck of any kind is needed.

The bin is typically not left unattended for extended periods in publicly accessible areas for safety and security reasons. If for any unforeseen reason the bin is left unattended, the system cannot easily be switched on and little opportunity to tamper or commit vandalism is provided. While technically the bin is configurable to operate without connection to truck power, in its current configuration the truck power functions as a safety. If the bin was left at a publicly accessible location for a period of time, an electrical safety switch (being truck power disconnect) renders the bin disabled so that bystanders cannot operate the bin.

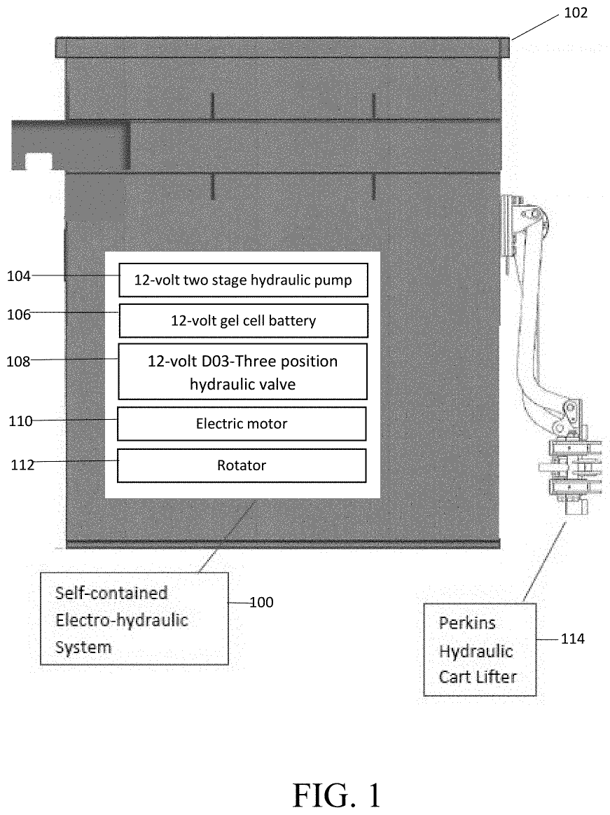

Turning to the figures, FIG. 1 is an image of a self-contained electro-hydraulic system according to an embodiment of the present disclosure. FIG. 1 depicts components of a system 100 comprising a bin 102, a 12-volt two stage hydraulic pump 104, referred to for brevity as the pump 104, a 12-volt gel cell battery 106, referred to for brevity as the battery 106, and a 12-volt D03-Three position hydraulic valve 108. The system 100 also comprises an electric motor 110, a rotator 112, and a Perkins hydraulic cart lifter 114, referred to for brevity as the lifter 114. While the lifter 114 is shown in FIG. 1 as a Perkins lifter, this depiction is for discussion purposes only as the lifter 114 may be provided by a manufacturer other than Perkins Manufacturing, Inc.

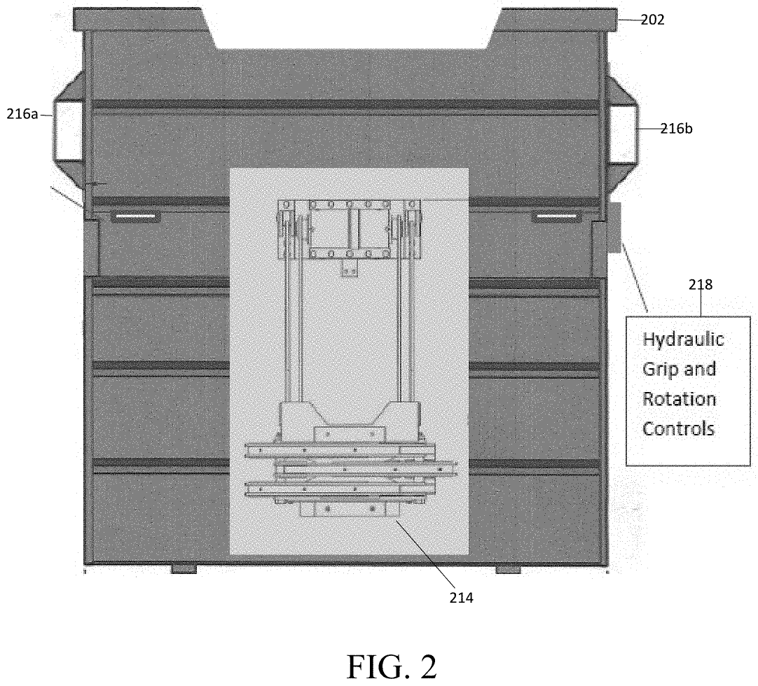

As noted, the bin may be a standard industry trash collection bin, approximately three to eight cubic yards in volume. The self-contained system 100 is situated on a side panel of the bin 102. The lifter 114 is attached to a front panel of the bin 102. When the bin 102 is being held by a medium-duty truck for moving as described above, the truck would be at the side opposite the panel holding the lifter 114. In FIG. 1, the truck would be at the left side of the bin 102. In FIG. 1, the lifter 114 is in folded and closed position. Components illustrated in FIG. 2 through FIG. 11 are indexed to components of the system 100 and illustrated at least in FIG. 1.

FIG. 2 is another image of a self-contained electro-hydraulic system. FIG. 2 depicts side pockets 216a-b of the bin 202 that are used by forks of the medium-duty truck to lift the bin 202. Also depicted are hydraulic grip and rotation controls 218, a control panel for activating components of the system 100.

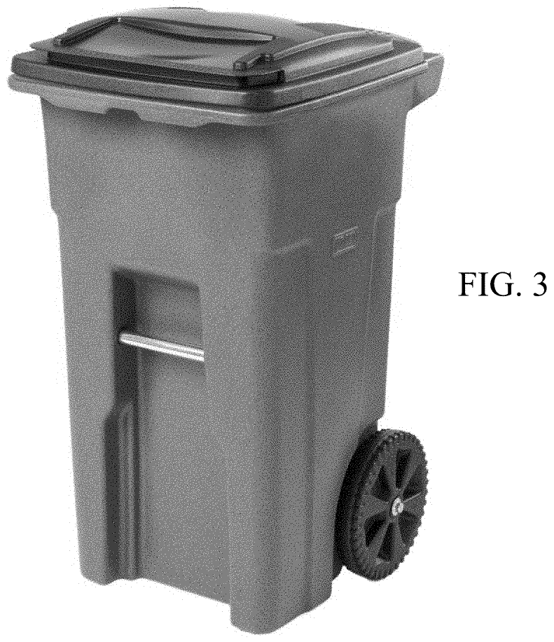

FIG. 3 is an image of a typical trash cart that may be lifted and emptied by the lifter 114. Depending on the weight of the contents in the cart, the system 100 may need to alter the hydraulic stage as discussed above. In embodiments, the trash cart may range in volumes from 32 gallons to 96 gallons.

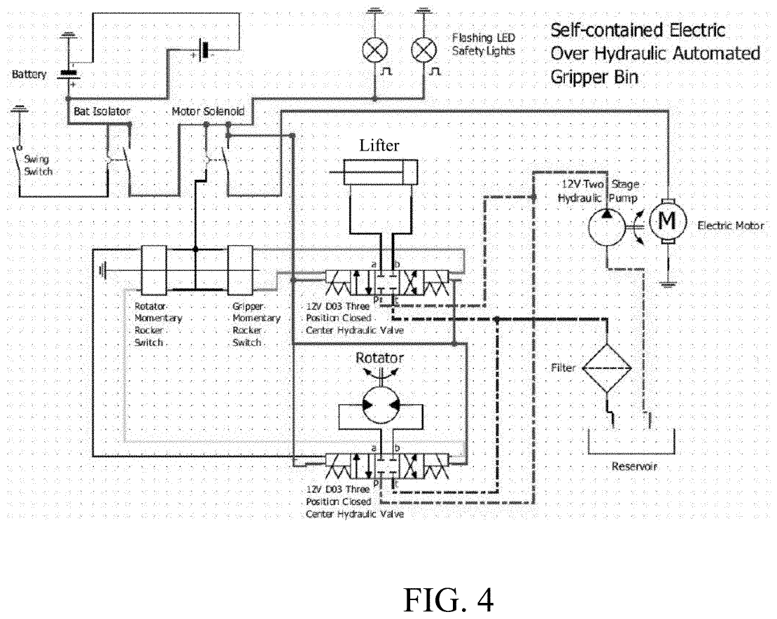

FIG. 4 is a schematic diagram of the system 100. Components are not labeled so as not to clutter FIG. 4. The 12-volt two stage hydraulic pump is shown near the electric motor. The two 12-volt D03-Three position hydraulic valves are also shown near the lifter, the valves regulating the hydraulic flow to the lifter.

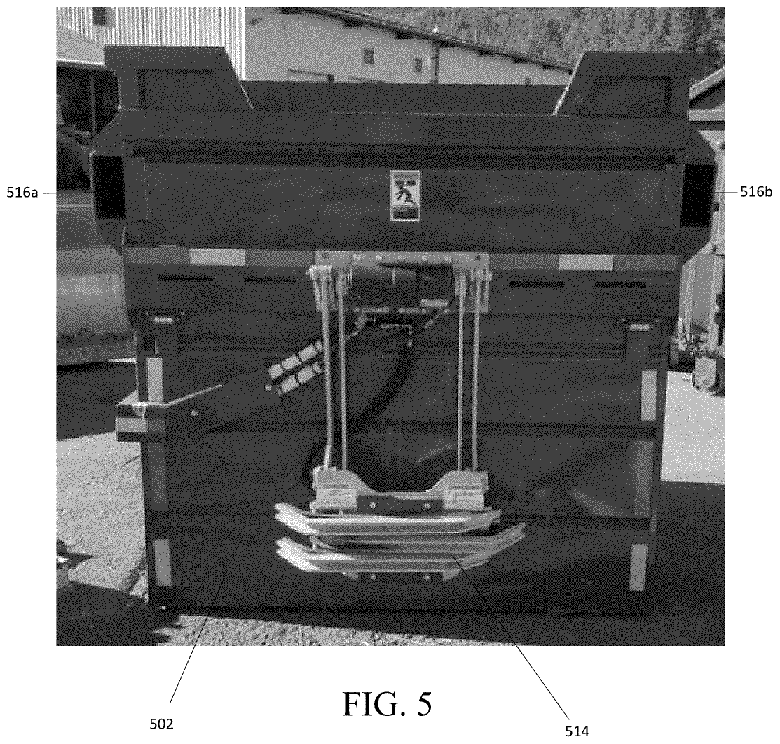

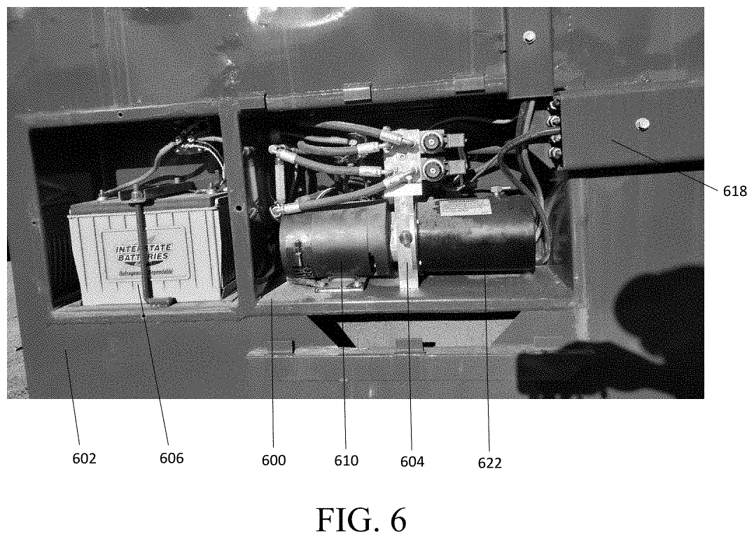

FIG. 5 is a front view of the bin 502 with lifter 514 in fully closed position. FIG. 6 is a view of a system 600 with battery 606, pump 604, motor 610, and reservoir 622 visible. As noted above, these and other components of the system 100 are located together in a side panel of the bin 602. Also depicted in FIG. 6 is a hydraulic cable channel 618 for hydraulic cables to pass from the system 600 to the lifter on the front of the bin 602.

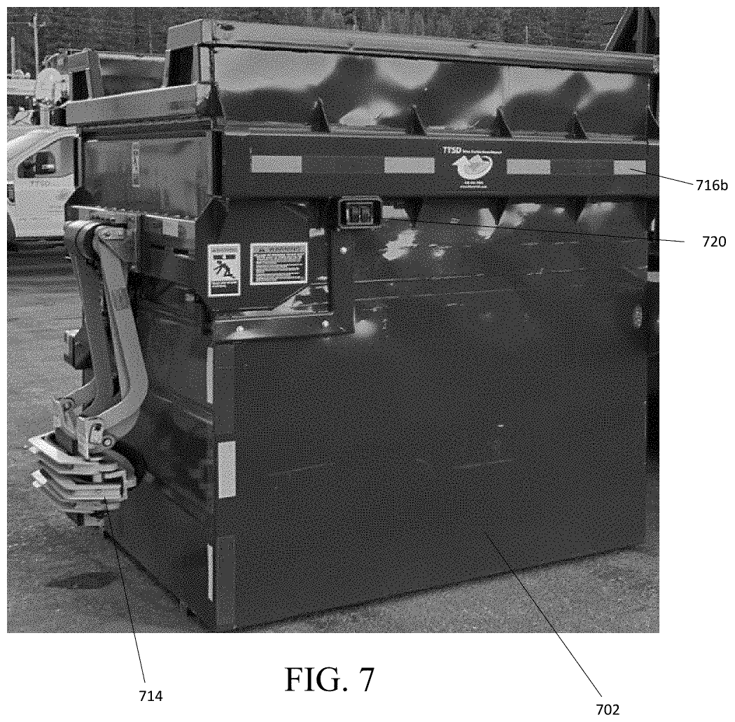

FIG. 7 is a view of the bin 702, the lifter 714 in closed position, and the side pocket 716b. Also depicted is a control panel 720 with controls for operating the system 700. The depiction of the control panel 720 in FIG. 7 is merely one possible embodiment. Other embodiments may comprise control configurations that include manual switches or fully automated lifting sequence with emergency stop. While one embodiment of the switch is a manual rocker switch, other embodiments may comprise adding a small circuit that may allow the bin 702 to fully tip the cart and set it back down via a single press of a button.

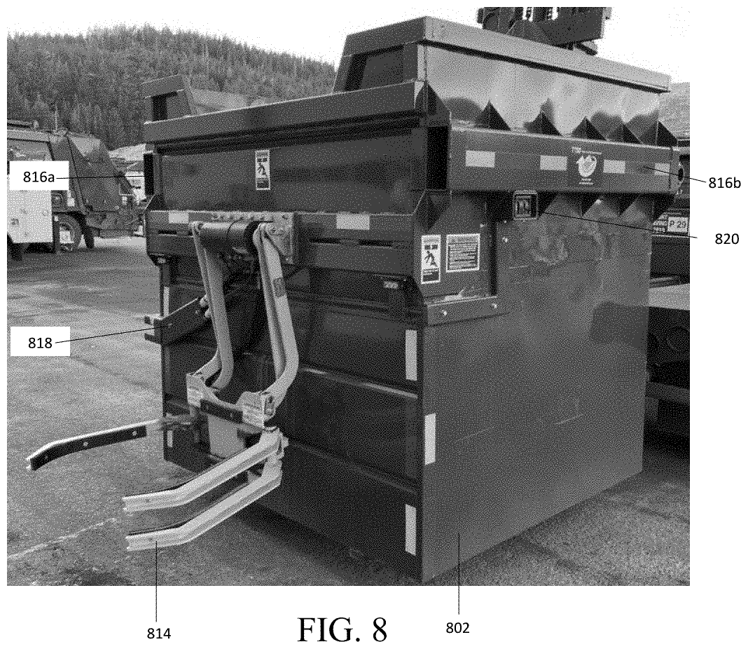

FIG. 8 is a view of the bin 802 and the lifter 814 in open position, with arms of the lifter 814 spread wide to grasp a trash cart. Also shown in FIG. 8 is the hydraulic cable channel 818 as well as the side pockets 816a-b and the control panel 820.

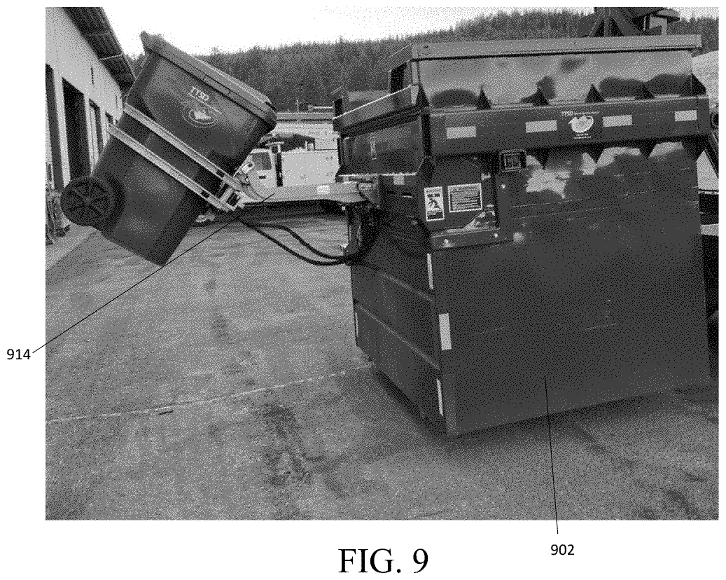

FIG. 9 is a view of the bin 902 and the lifter 914 in the process of lifting a cart. In the process of lifting a cart, the system may change the stage of the hydraulics based on hydraulic pressure as discussed above and not based on electrical circuit activity.

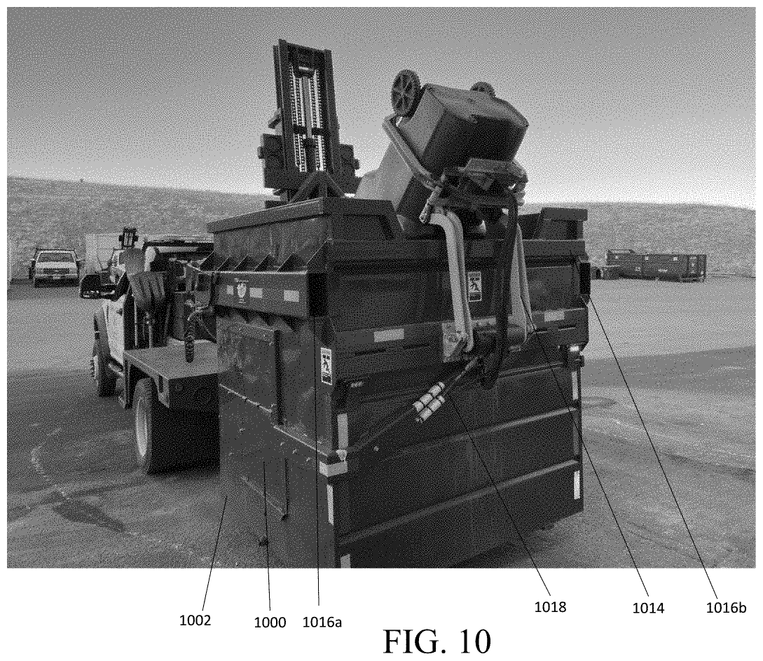

FIG. 10 is a view of the bin 1002 including the system 1000 depicted as a closed sliding door that contains the components shown in FIG. 1. Also shown in FIG. 10 is the hydraulic cable channel 1018 containing hydraulic lines that lead from the system 1000 to the lifter 1014.

In FIG. 10, the lifter 1014 is lifting a cart high up and over the bin 1002 and tipping or tilting the cart so that the contents of the cart empty into the bin 1002. Also depicted in FIG. 10 are the side pockets 1016a-b.

FIG. 10 also shows a medium-duty truck with its rear positioned against a back panel of the bin 1002. The back panel as referred to herein is in contrast to the front panel to which the lifter 114 is attached. As noted, the medium-duty truck, via its own onboard lifting mechanism including forks, raises the bin 1002 including system 1000 and lifter 1014 several feet off the ground. The medium-duty truck carries the bin 1002 to locations of other carts in a neighborhood, for instance.

The system, including bin 1002, lifter 1014, and internal components shown in FIG. 1, in most embodiments remains attached to the medium-duty truck to maintain power level of the 12-volt battery 106 and to be protected by safety functionality provided by the truck attachment.

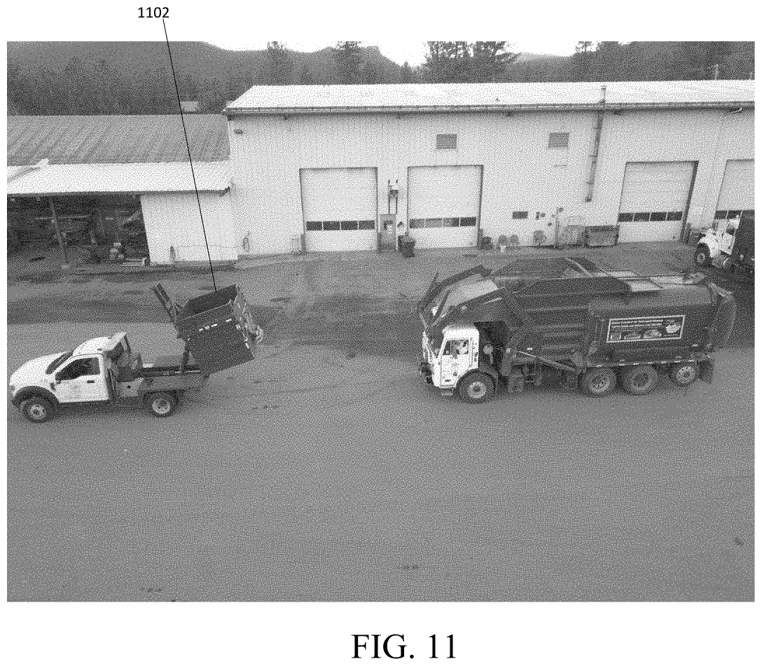

FIG. 11 is a view of the bin 1102 and the system 1100 as the bin 1102 is being lifted off the ground after the bin 1102 has been emptied by the front-loading compactor truck. In FIG. 11, the compactor truck is shown waiting for the medium-duty truck to move away from the compactor truck. The compactor truck in FIG. 11 has already lifted and emptied the bin 1102 as evidenced by the bin 1102 being empty.

In an embodiment, a self-contained electro-hydraulic system for trash collection is provided. The system comprises boxlike steel trash collection bin and a hydraulically activated trash cart lifter mounted on an outward-facing front surface of the bin. The system also comprises a control unit mounted on a side surface of the bin comprising a 12-volt battery, an electric motor, a rotator, and a two-stage hydraulic pump. The system hydraulically causes the lifter to grasp a trash cart positioned proximate the gripper. The system also changes, based on hydraulic pressure measurements, a stage of the pump from a first stage of about 5 gallons per minute to a second stage of about 1-2 gallons per minute. The system also lifts and tilts the cart based on the change in stage, enabling contents of the cart to fall into the bin. Power for the pump and lifting of the cart is supplied entirely by the 12-volt battery. The bin is moved between locations of trash carts by a medium-duty truck with a lifting mechanism. The lifting mechanism comprises at least forks that lift the bin via pockets on side surfaces of the bin. The bin, after visits to multiple locations of trash carts, is transported by the medium-duty truck to a central location and is decoupled from the medium-duty truck. Upon decoupling, the bin is lifted and emptied by a front-loading compactor truck. The system does not contact a hydraulic system of the medium-duty truck in lifting trash carts.

In another embodiment, a method for lifting and emptying trash carts without truck power is provided. The method comprises a two-stage hydraulic pump attached to a collection bin activating a cart lifter device mounted to a front surface of the bin. The method also comprises the pump causing the lifter device to grasp and commence lifting a first cart positioned proximate the tipper device. The method also comprises the pump, based on at least measurements of hydraulic pressure captured during commencement of lifting, altering hydraulic stage of the pump from a first stage of about 5 gallons per minute to a second stage of about 2 gallons per minute. The method also comprises the pump maintaining hydraulic pressure as the lifter device lifts and tilts the cart. The method further comprises an electric motor attached to the bin driving the pump. The method further comprises the motor receiving power from a 12-volt battery. The 12-volt battery is attached to the bin and is sole source of power for the pump and lifting of the bin. The bin is periodically moved by a medium-duty truck to locations of additional carts for emptying and to a central location for emptying of the bin by one of a front-loading truck and a rear-loading compactor truck. The system does not contact a hydraulic system of the medium-duty truck in lifting trash carts.

In yet another embodiment, a system for lifting and tilting trash carts independent of auxiliary hydraulic power is provided. The system comprises a cart lifter attached to a trash collection bin and a self-contained control apparatus attached to the bin that applies hydraulic pressure to the lifter to commence lifting of a trash car. Based on a first observed pressure, the system alters a pump stage associated with pressure and lifts and tilts the cart based on the altered pump stage. The self-contained control apparatus comprises at least a 12-volt battery, an electric motor, a rotator, and a two-stage hydraulic pump. The alteration of pump stage is from about 5 gallons per minute to about 1-2 gallons per minute. The trash collection bin is connected to a medium-duty truck and is moved between collection sites by the medium-duty truck The bin, after visits to multiple collection sites of trash carts, is transported by the medium-duty truck to a central location, is decoupled from the medium-duty truck, and is emptied by a trash compactor truck. The system does not rely on hydraulic power of the medium-duty truck to lift and tilt the trash cart. The apparatus does not rely on electric power of the medium-duty truck to lift and tilt the cart.

What is claimed is:

1. A self-contained electro-hydraulic system for trash collection, comprising:
a boxlike steel trash collection bin;
a hydraulically activated trash cart lifter mounted on an outward-facing front surface of the bin;
a control unit mounted on a side surface of the bin comprising:
a 12-volt battery,
an electric motor,
a rotator, and
a two-stage hydraulic pump that:
hydraulically causes the lifter to grasp a trash cart positioned proximate the gripper,
changes, based on hydraulic pressure measurements, a stage of the pump from a first stage of about 5 gallons per minute to a second stage of about 1-2 gallons per minute, and
lifts and tilts the cart based on the change in stage, enabling contents of the cart to fall into the bin.

2. The system of claim 1, wherein power for the pump and lifting of the cart is supplied entirely by the 12-volt battery.

3. The system of claim 1, wherein the bin is moved between locations of trash carts by a medium-duty truck with a lifting mechanism.

4. The system of claim 3, wherein the lifting mechanism comprises at least forks that lift the bin via pockets on side surfaces of the bin.

5. The system of claim 1, wherein the bin, after visits to multiple locations of trash carts, is transported by the medium-duty truck to a central location and is decoupled from the medium-duty truck.

6. The system of claim 5, wherein upon decoupling, the bin is lifted and emptied by a front-loading compactor truck.

7. The system of claim 1, wherein the system does not contact a hydraulic system of the medium-duty truck in lifting trash carts.

8. A method for lifting and emptying trash carts without truck power, comprising:
a two-stage hydraulic pump attached to a collection bin activating a cart lifter device mounted to a front surface of the bin;
the pump causing the lifter device to grasp and commence lifting a first cart positioned proximate the tipper device;
the pump, based on at least measurements of hydraulic pressure captured during commencement of lifting, altering hydraulic stage of the pump from a first stage of about 5 gallons per minute to a second stage of about 2 gallons per minute; and
the pump maintaining hydraulic pressure as the lifter device lifts and tilts the cart.

9. The method of claim 8, further comprising an electric motor attached to the bin driving the pump.

10. The method of claim 9, further comprising the motor receiving power from a 12-volt battery.

11. The method of claim 10, wherein the 12-volt battery is attached to the bin and is sole source of power for the pump and lifting of the cart.

12. The method of claim 8, wherein the bin is periodically moved by a medium-duty truck to locations of additional carts for emptying and to a central location for emptying of the bin by one of a front-loading truck and a rear-loading compactor truck.

13. The method of claim 8, wherein the system does not contact a hydraulic system of the medium-duty truck in lifting trash carts.

14. A system for lifting and tilting trash carts independent of auxiliary hydraulic power, comprising:
a cart lifter attached to a trash collection bin; and
a self-contained control apparatus attached to the bin that:
applies hydraulic pressure to the lifter to commence lifting of a trash cart
based on a first observed pressure, alters a pump stage associated with pressure; and
lifts and tilts the cart based on the altered pump stage.

15. The system of claim 14, wherein the self-contained control apparatus comprises at least:
a 12-volt battery,
an electric motor,
a rotator, and
a two-stage hydraulic pump.

16. The system of claim 14, wherein the alteration of pump stage is from about 5 gallons per minute to about 1-2 gallons per minute.

17. The system of claim 14, wherein the trash collection bin is connected to a medium-duty truck and is moved between collection sites by the medium-duty truck

18. The system of claim 14, wherein the bin, after visits to multiple collection sites of trash carts, is transported by the medium-duty truck to a central location, is decoupled from the medium-duty truck, and is emptied by a trash compactor truck.

19. The system of claim 14, wherein the apparatus does not rely on hydraulic power of the medium-duty truck to lift and tilt the trash cart.

20. The system of claim 14, wherein the apparatus does not rely on electric power of the medium-duty truck to lift and tilt the cart.
